(19) United States
(12) Patent Application Publication
(10) Pub. No.: US 2003/0031833 A1
(43) Pub. Date: Feb. 13, 2003

(54) Water-repellent films and method for forming such films

(76) Inventors: Hiroyuki Sugimura, Nagoya City (JP); Osamu Takai, Nagoya City (JP)

Correspondence Address: Robert G. Mukai, BURNS, DOANE, SWECKER & MATHIS, L.L.P., P.O. Box 1404, Alexandria, VA, 22313-1404, US

(21) Appl. No.: 10/167,079

(22) Filed: Jun. 12, 2002

(30) Foreign Application Priority Data
Jun. 12, 2001 (JP) 2001-177,046

(51) Int. Cl. B32B 3/00

(52) U.S. Cl. 428/156

(57) ABSTRACT

A water-repellent film is disclosed, which includes a first film portion possessing a number of fine pores having aspect ratios of not less than 0.1, and a second hydrophobic film portion on said first film portion.

### BACKGROUND OF THE INVENTION

(1) Field of the Invention

The present invention relates to water-repellent films and method for producing such water-repellent films. Particularly, the invention relates to water-repellent films comprising film portions having fine pores and methods for producing such water-repellent films.

(2) Related Art Statement

Studies have been actively made on materials having so-called water-repellent property that water is repelled from the materials. This is because that great demands are present, in areas having relatively much rainfalls, for materials that exhibit excellent water-repellent property, in industrial fields including automobile parts, building and construction materials and covering materials.

Fluorine-based resins are mainly now used for water-repellent treatment with films. A method is known, which affords water-repellent property by using such a fluorine-based resin dissolved in a solvent.

A method is also known, which affords water-repellent property upon surfaces of substrates by a plasma CVD or a sol-gel method.

However, the method for affording the water-repellent property upon the substrate by using the above fluorine-based resin dissolved in the solvent has an environment sanitation problem, since many fluorine-based resins are difficult to be dissolved in alcohol-based solvents having low toxicity.

Further, the method in which the water-repellent property is imparted by forming a film through one step such as the plasma or a sol-gel method can not allow films having desired properties to be formed, because films as underlying layers for the hydrophilic films cannot be finely adjusted.

On the other hand, it is desired that the water-repellent films can be applied upon various plastic articles so that the water-repellent films may be industrially applicable. In order to apply such films on the plastic articles, it is important that the water-repellent films are produced at lower temperatures. However, a method for producing highly water-repellent films at low temperatures has not been known yet.

### SUMMARY OF THE INVENTION

It is an object of the present invention to provide highly water-repellent films and method for producing such films at a lower temperature.

In order to realize the above object, the present inventors made various investigations upon films having fine uneven surfaces and hydrophobic films. As a result, the inventors accomplished the present invention.

The water-repellent film according to the present invention is characterized by comprising a first film portion possessing a number of fine pores having aspect ratios of not less than 0.1, and a second hydrophobic film portion on said first film portion.

The following are preferred embodiments of the water-repellent film according to the present invention. Any combinations thereof are also considered as preferred embodiments of the water-repellent film according to the present invention, provided that any contradiction does not occur.

(1) The aspect ratios of the fine pores are not more than 0.3.

(2) The first film portion has the fine pores having small and large open pore areas, and variations among depths of the fine pores having the large open pore areas are not more than 10 nm. It is intended in the specification and claims of the present application that the diameters of the large diameter open pore areas are more than 1 μm, and for example not more than 100 nm, while the diameters of the smaller diameter open pore areas are not more than 1 μm, and for example not less than sub-μm.

(3) The depths of the fine pores are not more than 1 μm.

(4) The average depth of the fine pores having the large open pore areas is not more than 500 nm. This is based on the fact that if the depth is around the wavelength of the light, scattering of the light is not conspicuous. Since the human eyes can recognize the light at the wavelength of 550 nm at the largest, they can sufficiently recognize lights slightly smaller than 550 nm. The average depth of the fine pores having the large open pore areas is preferably not more than 500 nm, more preferably not more than 300 nm.

(5) The first film portion comprises a polymer material.

(6) The polymer material of the first film portion comprises a vinyl-based polymer material.

(7) The vinyl-based polymer material is at least one polymer material selected from the group consisting of polymethyl methacrylate, polystyrene, polyethylene and polyvinyl chloride.

The thickness of the second hydrophobic film is preferably thin. Since unevenness of the first film will disappear if this thickness of the second hydrophobic film is too thick. The thickness of the hydrophobic film is preferably not more than the average depth of the fine pores.

The present invention also relates to a method for producing a water-repellent film, comprises the steps of: forming a film preform of a mixture of two or more kinds of polymer materials on a substrate by applying the mixture onto the substrate; forming a first film portion having a number of fine pores by removing at least one of said two or more kinds of the polymer materials from the film preform; and forming a second hydrophobic film portion on the first film portion having a number of the fine pores.

The present invention also relates to another method for producing a water-repellent film, comprises the steps of: forming a film preform of a mixture of two or more kinds of polymer materials on a substrate by applying the mixture onto the substrate; forming a first film portion having a number of fine pores by removing at least one of said two or more kinds of the polymer materials from the polymer mixture film; forming a replica using the first film portion having a number of the fine pores as a mold; and forming a second hydrophobic film portion on the replica.

As a preferred embodiment of the water-repellent film-producing method according to the present invention, the water-repellent film is formed on the substrate or the replica by at least one of spin coating and dip coating

As another preferred embodiment of the water-repellent film-producing method, said at least one of the polymer materials is removed by dissolving it off with an organic solvent.

As a further preferred embodiment of the water-repellent film-producing method, at least one of the polymer materials to be removed comprises a polystyrene, and the organic solvent comprises cyclohexane.

As a still further preferred embodiment of the water-repellent film-producing method according to the present invention, the replica is produced with a resin by at least one of transfer molding, injection molding and compression molding.

These and other objects, features and advantages of the present invention will be appreciated upon reading of the following description of the invention when taken in conjunction with the attached drawings, with the understanding that some modifications, variations and changes of the same could be easily made by the skilled person in the art.

### BRIEF DESCRIPTION OF THE DRAWINGS

For a better understanding of the invention, reference is made to the attached drawings, wherein:

FIG. 1 is a flow chart illustrating the procedure for producing a film portion having fine pores according to one embodiment of the present invention.

FIGS. 2(A) to 2(E) are atomic force microphotograph images_showing film portions having fine pores, FIG. 2(A) to FIG. 2(E) being directed to (A) PMMA: PS=1:0.5, (B) PMMA: PS=1:1, (C) PMMA: PS=1:2, (D) PMMA: PS=1:3, and (E) PMMA: PS=1:4, respectively, in which PMMA and PS are polymethyl methacrylate and polystyrene, respectively.

FIG. 3 shows the relationship between water-repellent films obtained by using the fine pore-possessing film portions (A) to (E), respectively and water drop contact angles.

FIGS. 4(A) and 4(B) show atomic force microphotograph images (AFM images) of a prototype (a fine pore-possessing film portion) A and a fine pore-possessing structure (B) transferred onto a silicon rubber member.

FIGS. 5(a) to 5(d) show concept figures for analysis of the surface roughness.

FIG. 6 shows results of the analysis of the surface roughnesses.

The water-repellent film according to the present invention is a first film portion having a number of fine pores of which aspect ratios (a ratio of a vertical size to a lateral size) is not less than 0.1, and a second hydrophobic film on said first film.

The above aspect ratio can realize excellent water-repellent effect for the film. The aspect ratios of the fine pores can be measured with respect to at least one arbitrary cross section. In order to obtain the aspect ratios with higher accuracy, they are preferably measured with respect to plural cross sections.

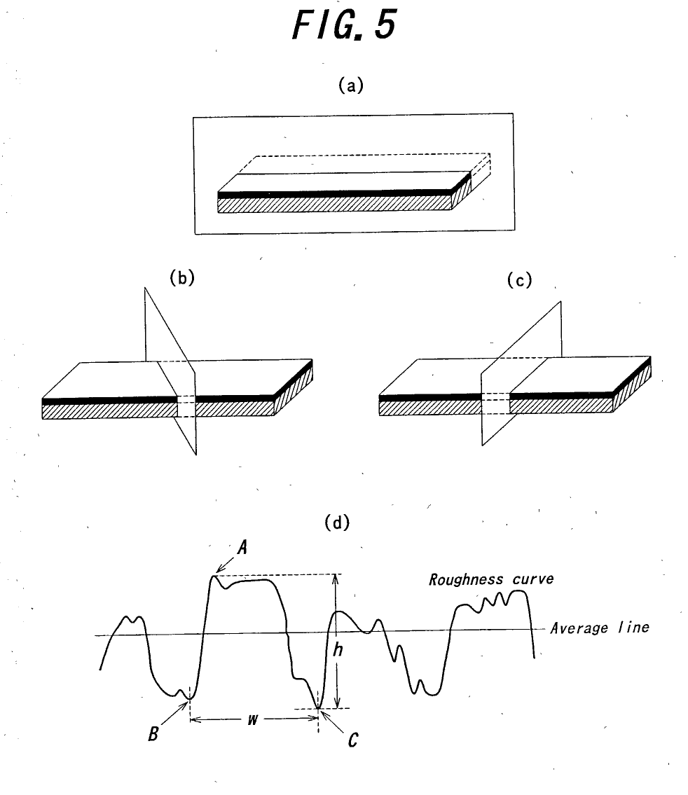

As one example, FIGS. 5(a) to 5(d) show a method for calculating aspect ratios. For example, three arbitrary cross sections are selected, and with respect to any selected cross section, a distance “w” between adjacent valleys under an average line in height of mountains and valleys as well as a distance “h” from the highest mountain in an area between the adjacent valleys to the lowest valley between said adjacent valleys, and an aspect ratio can be obtained by dividing “h” by “w”. The above average line is the average height of the mountains and valleys of the surface along the cross section as measured.

In order to enhance the precision, “n” aspect ratios: “a” values (=h/w) are determined with respect to the three cross sections, and the aspect ratio can be obtained by averaging n of the “a” values by determining the average value Ras according to the following formula (1).

$$R a s = \frac{1}{n} {\sum }_{i = 1}^{n} a$$

“a” denotes an aspect ratio (vertical/lateral ratio) for one projection. Ras value is the average aspect ratio of plural projections at the surface of the film, and the surface roughness of the film can be evaluated by using this Ras value.

In the present invention, the aspect ratio is not particularly limited, so long as it is not less than 0.1. The aspect ratio can be increased by varying the mixing ratio of the polymer materials or changing the molecular weight of the polymer materials, for example, as mentioned later. The aspect ratio means the ratio between a lateral size and a vertical size, provided that the lateral size and the vertical size may be taken in any perpendicular directions. The ratio in area between the fire pores and the non-pore portion may be preferably around 1:1. This ration may be presumed preferable from 1:3 to 3:1.

From the standpoint of easily obtain practical water-repellent property, the aspect ratios of the fine pores are not more than 0.3. However, in order to afford higher water-repellent property upon the film, the aspect ratio may be greater than 0.3.

The water-repellent film according to the present invention may use a film portion having a number of fine pores possessing different open pore areas as its underlying layer.

In the present invention, the first film portion has the fine pores having small and large open pore areas, and variations among depths of the fine pores having the large open pore areas are not more than 10 nm. It is intended in the specification and claims of the present application that the large diameter open pore areas are more than 1 μm, and for example not more than 100 nm as measured in diameter, while the smaller diameter open pore areas are not more than 1 μm, and for example not less than sub-μm as measured in diameter.

Further, although the depths of the fine pores in the water-repellent film according to the present invention vary depending upon uses therefor and are not particularly limited, the depths are generally in a range of 0.01 to 1 μm, and more preferably not more than 0.5 μm. The reason for this range is that light scattering is made as less as possible and transparency of the film is kept.

The depths of the fine pores having large open pore areas, which depend upon uses for the material, are not particularly limited. In general, the fine pores are in the depth range of 0.01 to 1 μm. The depth range is preferably not more than 500 nm on the average. The reason for such a range is that light scattering is suppressed to ensure the transparency.

The fine pore-possessing film portion may be made of a polymer material, for example, and the polymer material is preferably a vinyl-based polymer material. For example, polymethyl methacrylate (PMMA), polystyrene, polyethylene and polyvinyl chloride may be recited as such a vinyl-based polymer material. Among them, the polymethyl methacrylate (PMMA) may be preferably recited as the polymer material in that the PMMA gives high water repellency, high mechanical durability and transparency.

The film portion having the above fine pores may be preferably formed according to the following method for the preparation of the water-repellent film.

According to the water-repellent film-forming method of the present invention, a film preform of mixed two or more polymer materials is first formed on a substrate by applying the polymers thereon. Then, a first film portion having a number of fine pores may be formed by removing at least one kind of the polymer materials from the film preform of the mixed polymers.

The film preform may be formed on the substrate by at least one method selected from the group consisting of spin coating and dip coating. In the spin coating and the dip coating, it may be that a mixed solution of the polymer materials is prepared in an appropriate solvent by dissolving the polymer materials into the solvent, and the film preform is formed on the substrate by using the mixed solution. As such a solvent, tetrahydrofuran (THF), acetone or the like may be recited as such the solvent, for example.

The spin coating is effected under ordinary condition, for example, in 1 to 30 seconds at a rotation rate of 200˜2500 rpm. The spin-coating condition may be appropriately varied depending upon the water-repellent film desired, and may be set under other condition than as recited above, as the case may be. The spin coating and/or dip coating may be effected at plural numbers of times. When coating is effected at plural numbers of times, the thickness of the film can be advantageously increased.

The water-repellent film according to the present invention comprises the film portion having the above-mentioned fine pores and the hydrophobic film portion on the former film portion. As the material for the hydrophobic film portion, conventional materials for the hydrophobic films may be recited, and not restricted. As the material for such a hydrophobic film, silane compounds such as tetramethoxy silane, hydrocarbons, fluorocarbon, etc. may be recited, for example.

The removal of the polymer material(s) is not limited to any method. Preferably, at least one polymer material may be removed by dissolving it in an organic solvent. The reason why at least one polymer material is removed by dissolving it in the organic solvent in this manner is that this may be effected at room temperature.

In the case of the removal with the organic solvent, such an organic solvent may be appropriately selected depending upon the polymer material(s) to be removed. A preferred combination of the polymer material and the organic solvent capable of dissolving the polymer material is that the polymer material to be removed is polystyrene and the organic solvent is cyclohexane. Such a combination is preferred in that PMMA is not dissolved in cyclohexane.

The mixed ratio between the polymer material remaining as the fine pore-structural skeleton and the polymer material(s) to be removed may be appropriately varied depending upon intended uses of the water-repellent material.

For example, the mixed ratio between the polymer material remaining as the fine pore-structural skeleton and the polymer material(s) to be removed may be 1:0.1 to 5. More preferably, this ratio may be 1:1 to 2. The reason why the mixing ratio is preferably 1:1 to 2 is that the depths of the fine pores are more uniform when the ratio is in this range, so that the water-repellent property may be improved.

A hydrophobic film portion can be formed on the thus formed film having a number of fine pores. The formation of the hydrophobic film is not particularly limited, but an ordinary method may be used. For example, a chemical vapor deposition such as plasma CVD or hot CVD, physical vapor deposition such as vacuum deposition or self-assembled monolayer-film formation may be used. Particularly, the chemical vapor deposition is preferred, because the film may be synthesized at a temperature far lower than the melting point of the material to form the film, its composition can be easily controlled, a multi-layer film can be formed and the film has high adhesion. In particular, the plasma CVD, the optical CVD and the like are preferred, because the substrate needs not be heated, and the film can be formed at a low temperature.

According to another aspect of the present invention, after a fine pore-possessing film portion is formed, a hydrophobic film portion may be formed on a replica which is prepared using the fine pore-possessing film as a mold. For, similar water-repelling effect can be obtained by preparing such a replica and forming the hydrophobic film portion on the replica.

The production of the replica is not particularly limited, but an ordinary method may be used. Preferably, the replica may be produced by transfer molding, injection molding or compression molding with resin.

In the case of the transferring with the resin, a thermosetting resin such as silicone rubber or epoxy resin or the like may be recited as the resin. Silicone rubber is preferred as the resin from the standpoint that the fine pore structure can be transferred to the fine portions. The transfer molding may be carried out by coating and curing non-cured silicone rubber on the film and peeling the cured rubber therefrom. The film is desirably coated with the non-cured resin at not more than a glass transition point at which the polymer material such as PMMA is not deformed with heat.

In the case of the injection molding and the compression molding, a transfer mold is first prepared by nickel electroforming, and a finely uneven structure is transferred onto a substrate with an injection mold or a compression mold by using the transfer mold.

### EXAMPLES

The present invention will be explained in more detail with reference to Examples, which are not intended to be interpreted as limit the invention.

### Example 1

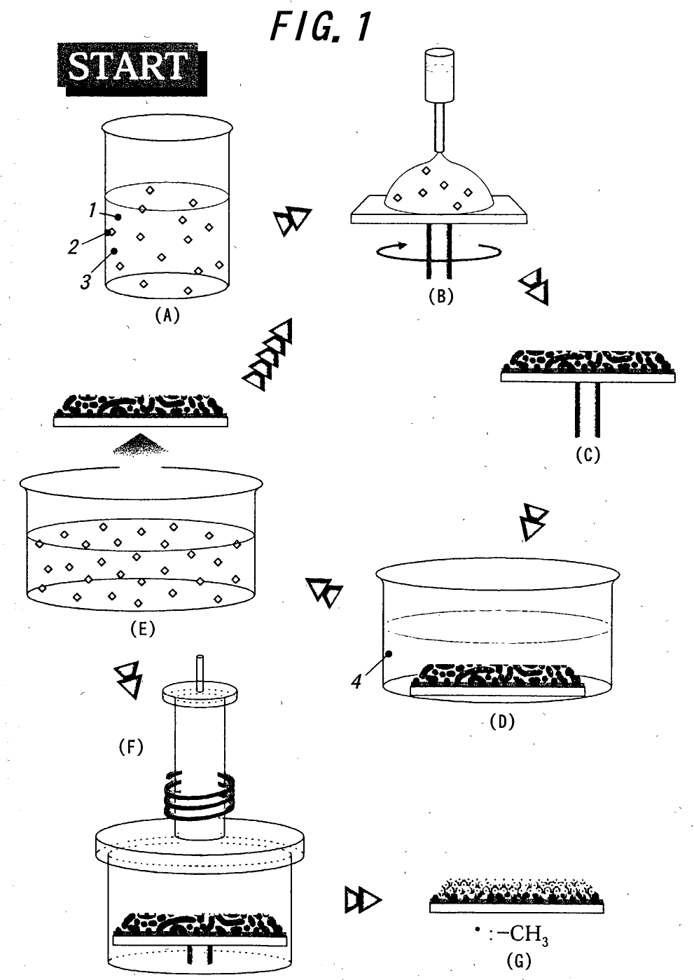

FIGS. 1(A) to 1(G) shows a procedure for the preparation of a microporous film. FIG. 1(A) shows a mixed solution of PMMA1, PS2 and THF3, and FIG. 1(B) illustrates spin coating. FIG. 1(C) illustrates a film of the PMMA-PS polymers formed. FIG. 1(D) illustrates removal of the polymer material in an organic solvent. FIG. 1(E) illustrates the formation of a fine pore-possessing film. FIG. 1(F) illustrates the hyrophobic treatment of the film with plasma CVD. FIG. 1(G) illustrates a water-repellent film completed.

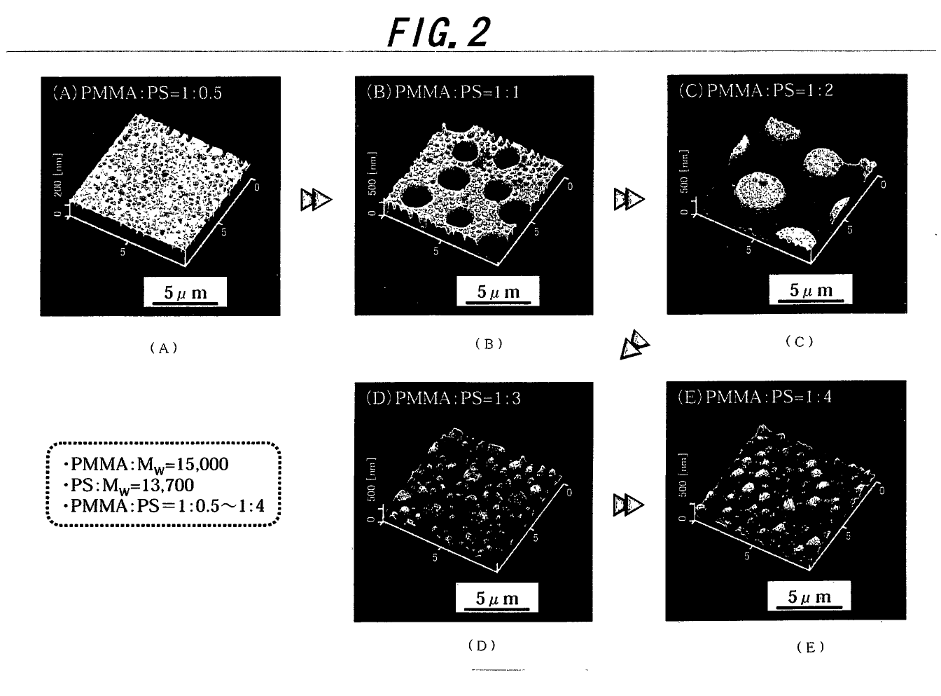

A tetrafuran (THF) solution of polymethyl methacrylate (PMMA: molecular weight—about 150,000) and polystyrene (PSs: molecular weight: about 13,700) was first prepared, and a film preform of the PMMA-PS mixture was formed by spin casting. The spin casting condition comprised two steps: 500 rpm & 2 minutes and 2000 rpm & 10 seconds. Then, the mixture film was washed with cyclohexane (CH) for 90 seconds. As a result, the PS was dissolved out with only CH, and the microporous film was obtained. In actual, the procedure of the spin casting and the CH washing was repeated twice, thereby obtaining the microporous film sample. AFM (atomic force microscope) photographs of the thus obtained microporous films are shown in FIGS. 2(A) to 2(E). As is seen from FIGS. 2(A) to 2(E), the phase separation structure varies depending upon the mixed ratio of PMMA:PS.

A hydrophobic thin film was coated onto each of such microporous films by the plasma CVD method. The film was treated with tetramethoxy silane as a raw material under condition of high frequency output 200 W and pressure 100 Pa for 10 minutes. Under this condition, a film was formed on a flat substrate, and this film exhibited high water-repellency that the water drop contact angle was about 103 degrees.

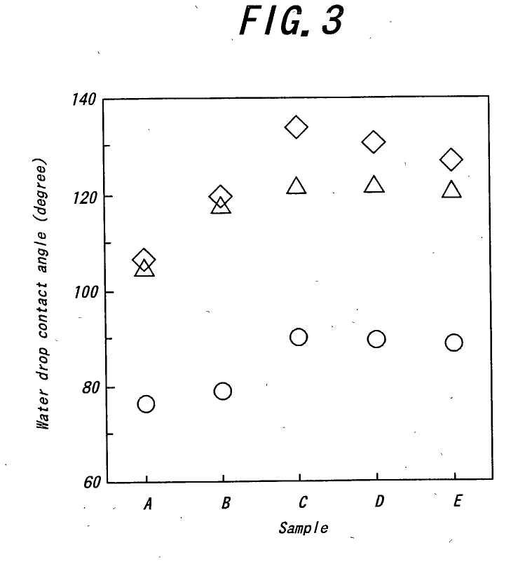

FIG. 3 shows water drop contact angles of Samples A to E. ◯ denotes a water drop contact angle of a phase separation structural film in which PS is not dissolved off with CH, Δ a water drop contact angle of a phase separation structural film in which PS is dissolved off with CH, and ⋄ a water drop contact angle of the microporous film treated hydrophobic. Each sample exhibited a water drop contact angle larger than 103 degrees which is the contact angle of the hydrophobic film. Thus, it is seen that the uneven surface structure of microporous film is enhanced. Particularly, the sample C exhibited a high contact angle of 135° C.

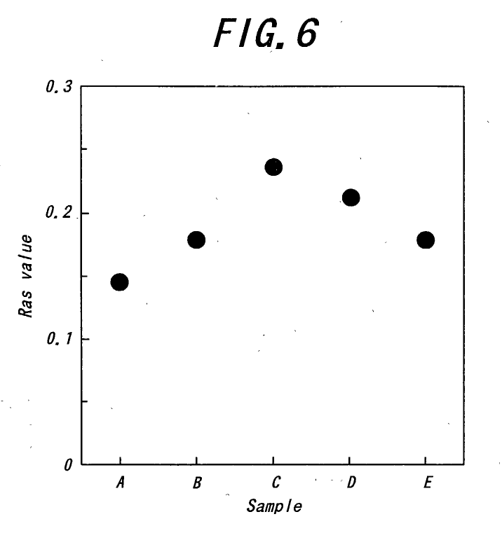

Next, Ras values of the samples A to E were determined, and shown in FIG. 6.

### Example 2

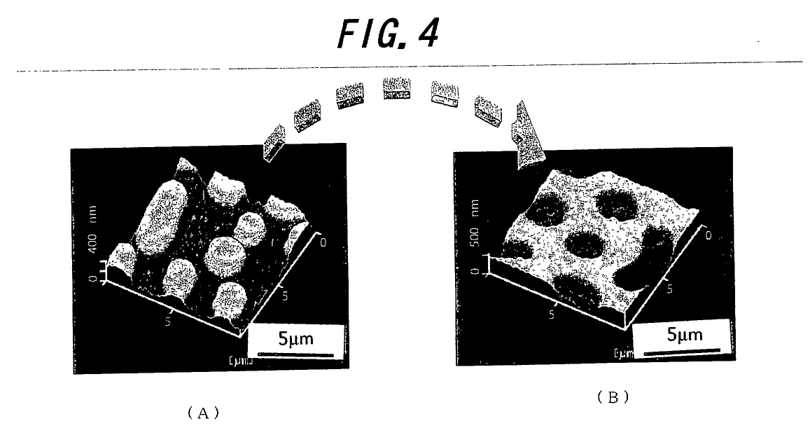

An uneven surface structure of each of the microporous films was transferred with silicone rubber. The fine structure of the microporous film prepared at a PMMA:PSS mixed ratio=1:2 was transferred with silicon rubber (TSE 3453T manufactured by Toshiba Silicone Co., Ltd). FIGS. 4(A) and 4(B) show AFT photographs of a prototype (microporous film) and a microstructure (B) transferred onto the silicone rubber, respectively. It is seen that the microstructures are transferred to fine portions or meticuously.

When the surface of the micro-structured silicone rubber was coated with a hydrophobic film by plasma CVD, the resultant exhibited high water-repellency with a water drop contact angle of about 130 degrees.

The highly water-repellent micro-structured silicone rubber thus obtained can be bonded to a curved surface of an object due to its flexibility.

The water-repellent film according to the present invention produces advantageous effects that the film exhibits high water-repellency and can be applied onto a plastic part.

When applied to the automobile window, the water-repellent film according to the present invention can be advantageously used as a wiperless window.

When the water-repellent film is used as a surface film for an optical part, the film has an advantageous effect that the optical parts which are difficult to be contaminated with stain can be offered.

Since the water-repellent film-producing method according to the present invention can be performed at a low temperature, the method has an advantageous effect that the water-repellent film formed can be applied to plastic parts, etc.

What is claimed is:

1. A water-repellent film comprising a first film portion possessing a number of fine pores having aspect ratios of not less than 0.1, and a second hydrophobic film portion on said first film portion.

2. The water-repellent film set forth in claim 1, wherein the aspect ratios of the fine pores are not more than 0.3.

3. The water-repellent film set forth in claim 1 or 2, wherein the first film portion has the fine pores having small and large open pore areas, and variations among depths of the fine pores having the large open pore areas are not more than 10 nm.

4. The water-repellent film set forth in claim 3, wherein the depths of the fine pores are not more than 1 μm.

5. The water-repellent film set forth in claim 3 or 4, wherein the average depth of the fine pores having the large open pore areas is not more than 500 nm.

6. The water-repellent film set forth in any one of claims 1 to 5, wherein the first film comprises a polymer material.

7. The water-repellent film set forth in claim 6, wherein the polymer material comprises a vinyl-based polymer material.

8. The water-repellent film set forth in claim 7, wherein the vinyl-based polymer material is at least one polymer material selected from the group consisting of a polymethyl methacrylate, a polystyrene, a polyethylene and a polyvinyl chloride.

9. A method for producing a water-repellent film, comprises the steps of:
forming a film preform of a mixture of two or more kinds of polymer materials on a substrate by applying the mixture onto the substrate;
forming a first film portion having a number of fine pores by removing at least one of said two or more kinds of the polymer materials from the film preform; and
forming a second hydrophobic film portion on the first film portion having a number of the fine pores.

10. A method for producing a water-repellent film, comprises the steps of:
forming a film preform of a mixture of two or more kinds of polymer materials on a substrate by applying the mixture onto the substrate;
forming a first film portion having a number of fine pores by removing at least one of said two or more kinds of the polymer materials from the polymer mixture film;
forming a replica using the first film portion having a number of the fine pores as a mold; and
forming a second hydrophobic film portion on the replica.

11. The film-producing method set forth in claims 9 or 10, wherein the film is formed on the substrate or the replica by at least one of spin coating and dip coating.

12. The film-producing method set forth in any one of claims 8 to 10, wherein said at least one of the polymer materials is removed by dissolving it off with an organic solvent.

13. The film-producing method set forth in claim 11, wherein at least one of the polymer materials to be removed comprises a polystyrene, and the organic solvent is cyclohexane.

14. The film-producing method set forth in any one of claims 9 to 12, wherein the replica is produced with a resin by at least one of transfer molding, injection molding and compression molding.
